(19) United States
(12) Patent Application Publication
(10) Pub. No.: US 2024/0058990 A1
(43) Pub. Date: Feb. 22, 2024

(54) METHOD FOR CUTTING CONCRETE MEMBER

(71) Applicants: JAPAN AGENCY FOR MARINE-EARTH SCIENCE AND TECHNOLOGY, Kanagawa (JP); TOKYO ELECTRIC POWER SERVICES CO., LTD., Tokyo (JP)

(72) Inventors: Yousuke KAWAHITO, Kanagawa (JP); Muneo HORI, Kanagawa (JP); Yasuhiro SHIMANE, Kanagawa (JP); Toshihiro KAMEDA, Kanagawa (JP); Lalith Wijerathne MADDEGEDARA, Kanagawa (JP); Hiroyuki YOSHIDA, Tokyo (JP); Kohei OTA, Tokyo (JP); Tatsuya NAKADA, Tokyo (JP); Tatsuya MASE, Nara (JP)

(21) Appl. No.: 18/267,828

(22) PCT Filed: Dec. 13, 2021
(86) PCT No.: PCT/JP2021/045807

§ 371 Date: Jun. 16, 2023

(30) Foreign Application Priority Data
Dec. 18, 2020 (JP) 2020-210182

(51) Int. Cl. B28D 1/22; B23K 26/38; B23K 26/082

(52) U.S. Cl. CPC B28D 1/221; B23K 26/38; B23K 26/082; B23K 2103/50

(57) ABSTRACT

The purpose of the present invention is to provide an easy-to-use and efficient method for cutting a concrete member, in particular, a method that is for cutting a reinforced concrete member, that makes it easy to increase cutting depth and cutting width, and that is low in cutting cost. To achieve the purpose, the present invention provides a method for cutting a concrete member through irradiation of the concrete member with laser, the method being characterized in that: the concrete member includes a steel material; concrete is melted by scanning laser thereon to form a cutting region; the steel material is heated by means of laser to a temperature that causes progression of self-burning of the steel material; and the melting of the concrete is expedited by heat generation from said self-burning.

### TECHNICAL FIELD

The present invention relates to a method for cutting concrete member, and more particularly to an efficient method for cutting reinforced concrete member.

### BACKGROUND ART

Since the laser beam has no mass, laser processing can be performed basically without noise and vibration, and not only processing and welding of metal materials, but also processing of concrete materials is attracting attention, and the investigation into the applicability of use in construction field has been studied.

For example, Patent Document 1 (JP2017-25631A) proposes, for the purpose of providing a structure dismantling method that can easily maintain the posture of concrete members after cutting, a structure dismantling method for dismantling a structure where a plurality of concrete members are combined, which has a cutting step of cutting the concrete member by irradiating a laser from a laser device, where in the cutting step, the laser device cuts the concrete member obliquely upward, and at the same time a non-cut portion is formed in a partial region of the cut surface.

In the structure dismantling method described in Patent Document 1, it is said that an oblique cut surface can be formed, and the concrete member after cutting can be supported by the oblique cut surface to maintain its posture. Further, it is said that, in the cutting step, the laser device forms a non-cutting portion in a partial region of the cut surface, and supports the gap of the cut surface with the non-cutting portion, thereby, when cutting the concrete member obliquely upward. it is possible to suppress the obstruction of cutting due to clogging of gaps in the cut surface, and which makes the cutting easy. Furthermore, it is said that when using a laser, it is possible to easily form the non-cutting portion on the cut surface as compared with other cutting methods.

Further, Patent Document 2 (JP2018-171628A) proposes, regarding laser cutting of concrete structures, for the purpose of performing a laser cutting well with increasing the removability of molten material, a laser cutting device for cutting the object by a laser which includes a laser nozzle that irradiates a laser beam onto a cut portion of the object; an assist gas spraying section that sprays an assist gas onto a molten material generated by melting the cut portion of the object with the laser beam; and a laser heating section which irradiates the molten material with the laser beam and heating the molten material.

In the laser cutting device described in Patent Document 2, it is said that the temperature of the molted material melted by the laser beam emitted from the laser nozzle is lowered by the assist gas sprayed from the gas spraying section, but by irradiating the laser beam onto the molten material in the laser heating section, the molten material is heated to be able to suppress the lowering of the fluidity of the molten material. Further, it is said that by moving the laser nozzle backward in the cutting direction to irradiate the laser beam onto the molten material, the molten material can be heated to be able to suppress the lowering of fluidity, and by functioning the laser nozzle as the laser heating section, there is no need to separately provide the laser heating section.

### PRIOR DOCUMENTS

### Patent Documents

Patent Document 1: JP2017-25631A
Patent Document 2: JP2018-171628A

### SUMMARY OF THE INVENTION

### Problem to be Solved by the Invention

However, the structure dismantling method described in Patent Document 1 is intended to maintain the posture of the concrete member after cutting, and is not intended to efficiently cut the concrete member. Further, the cutting direction of the concrete member is also limited. Furthermore, the laser cutting device described in Patent Document 2 performs cutting while ensuring fluidity by reheating the molten material by the laser irradiation, but even when the reheating is conducted, the viscosity of the molten concrete is relatively high, and thus it is extremely difficult to obtain a sufficient cutting efficiency and cutting depth.

In view of the problems in the prior art as described above, an object of the present invention is to provide an easy-to-use and efficient method for cutting concrete member, in particular, a method for cutting reinforced concrete member, that makes it easy to increase cutting depth and cutting width, and is low in cutting cost.

### Solution to Problem

In order to achieve the above object, as the result of extensive research with respect to the method for cutting concrete members by using a laser, the inventor of the present invention has found that, in the concrete member where steel material is used as a reinforcing member, it is extremely important to utilize heat generation due to self-burning of the steel material, etc., and then reached the present invention. Namely, the method for cutting concrete member of the present invention utilizes the self-burning phenomenon, which should be avoided in laser cutting of the steel material, to efficiently cut the concrete member.

Namely, the present invention is a method for cutting concrete member through irradiation of the concrete member with a laser, the method being characterized in that:
the concrete member includes a steel material,
the concrete is melted by scanning the laser thereon to form a cutting region,
the steel material is heated by means of the laser to a temperature that causes
progression of self-burning of the steel material, and
the melting of the concrete is accelerated by heat generation from the self-burning.

In the method for cutting concrete member of the present invention, in addition to melting the concrete by using the laser irradiation, the greatest feature is that the heat generated by the self-burning of the steel material contained in the concrete member accelerates the melting of the concrete. The temperature rise of the steel material for promoting the self-burning can be easily achieved by the laser irradiation.

The self-burning phenomenon in the laser cutting of steel material is that the steel material and the assist gas (oxygen) react excessively, and the kerf grows not only in the laser irradiation area but also in the area where the assist gas (oxygen) is sprayed, which is a phenomenon in which the roughness of the cut surface is significantly reduced. On the other hand, the “self-burning” in the method for cutting concrete member of the present invention does not essentially require the use of the assist gas, and broadly includes the phenomenon of the heat generation by the reaction between the steel material and oxygen due to the temperature rise caused by the laser irradiation. That is, in order to promote the self-burning phenomenon, it is preferable to use an assist gas containing oxygen, but even when the assist gas containing oxygen is not used, the self-burning phenomenon may be proceeded, for example by the oxygen in air.

The self-burning phenomenon at the laser cutting of steel material tends to progress due to excessive heat input by the laser and in the area where heat is easily accumulated, such as corners of the steel material. Here, in the method for cutting concrete member of the present invention, the steel material is surrounded by the concrete material with low thermal conductivity, and the situation is such that the self-burning of the steel material is likely to occur. In addition, when cutting the concrete member with a laser, since it is necessary to melt the concrete region, which is a material with a high melting point, the laser scanning speed becomes lower in comparison with the case the steel material is cut by the laser. That is, since the conditions are set such that the steel material is in a state of excessive heat input, the self-burning can be efficiently utilized.

As the self-burning of the steel material progresses, since the heat generation accelerates the melting of the concrete region, the melting of the concrete material in the vicinity of the steel material is significant. As a result, since the flow amount of the molten concrete member from the vicinity of the steel material increases, the presence or absence of the self-burning of the steel material can be easily confirmed from the discharge state of the molten concrete during the cutting.

The kind and shape of the steel material contained in the concrete member is not particularly limited as long as the effect of the present invention is not impaired, and various conventionally known steel materials and their shapes can be used, and when the concrete member is a usually used reinforced steel concrete or reinforced steel framed concrete, it is possible to efficiently cut by the method for cutting concrete member according to the present invention.

Further, in the method for cutting concrete member of the present invention, it is preferable that the cutting region is formed by using the side surface of the laser. When the laser is focused on the end surface of the concrete member and irradiated with the laser in a spot shape, the concrete member melts from the irradiation area, and the molten concrete flows out to form a point-like recess portion. After that, the concrete member can be cut by enlarging the recess portion in the depth direction and/or the width direction, but the molten concrete with high viscosity is not easily removed, and the cutting process is not smooth. On the other hand, by cutting the concrete member like slicing by using the side surface of the laser, the molten concrete can be removed efficiently and a long cutting line can also be formed at once.

Further, in the method for cutting concrete member of the present invention, it is preferable to start the cutting from the outer peripheral surface of the concrete member. When starting the cutting from the outer peripheral surface of the concrete member, a wide opening is formed in the outer peripheral surface of the concrete member, and the molten concrete is efficiently removed from the opening, so that the cutting can proceed smoothly.

Further, in the method for cutting concrete member of the present invention, it is preferable that the side surface of the laser is brought into contact with the outer peripheral surface of the concrete member at the start position of the cutting, and the position of the laser is fixed until the molten region of the concrete is formed around the entire circumference of the laser. When forming the molten region of the concrete around the entire circumference of the laser while the side surface of the laser is brought into contact with the outer peripheral surface of the concrete member, the energy of the laser can be fully utilized.

Further, in the method for cutting concrete member of the present invention, it is preferable that at least part of the bottom surface of the concrete member is included in the start position of the cutting. When providing the cutting area on at least a part of the bottom surface of the concrete member at the start of the cutting, the molten concrete can be efficiently discharged by gravity.

Further, in the method for cutting concrete member of the present invention, it is preferable that the laser is scanned from the lower side of the concrete member in the direction of gravity toward the upper side in the direction of gravity to form the cutting area, and the molten concrete is discharged from the cutting area by gravity. When scanning the laser from the lower side of the concrete member in the direction of gravity toward the upper side in the direction of gravity to form the cutting area, the concrete melted by the laser is discharged downward in the direction of gravity, and it is possible to achieve the extremely efficient cutting.

Further, in the method for cutting concrete member of the present invention, it is preferable that the scanning direction of the laser is substantially vertical. When making the scanning direction of the laser substantially vertical, it is possible to make the most of gravity from the viewpoint of discharging the molten concrete.

Further, in the method for cutting concrete member of the present invention, the laser output and power density may be appropriately set according to the desired cutting speed and the size and material of the member to be joined, and it is preferable to set the power density to an appropriate value or more according to a beam diameter of the laser. More specifically, when the beam shape in the irradiation area is substantially circular, it is preferable that the power density is 3.5 kW/mm² or more when the beam radius is 1.2 mm, the power density is 1.0 kW/mm² when the beam radius is 2.2 mm, the power density is 0.5 kW/mm² or more when the beam radius is 3.2 mm, the power density is 0.3 kW/mm² or more when the beam radius is 4.2 mm, the power density is 0.2 kW/mm² or more when the beam radius is 5.2 mm. When setting the power density to these values, the concrete member can be efficiently melted.

Furthermore, in the method for cutting concrete member of the present invention, the scanning speed of the laser may be appropriately set according to the output and power density of the laser to be used, the size and material of the member to be joined, and the like, and it is preferable that the scanning speed of the laser is 5 to 50 mm/min. When setting the laser scanning speed to 5 mm/min or more, a practical cutting speed for cutting the concrete members can be secured, and when setting to 50 mm/min or less, it is possible to accelerate the progress of the self-burning and the discharge of the molten concrete.

### Effects of the Invention

According to the method for cutting concrete member of the present invention, it is possible to provide an easy-to-use and efficient method for cutting concrete member, in particular, a method for cutting reinforced concrete member, that makes it easy to increase cutting depth and cutting width, and is low in cutting cost.

### BRIEF DESCRIPTION OF THE DRAWINGS

FIG. 1 is a schematic diagram showing a state of the pre-stage of the cutting in the method for cutting concrete member of the present invention.

FIG. 2 is a schematic diagram showing a state of the laser contact stage in the method for cutting concrete member of the present invention.

FIG. 3 is a schematic diagram showing a state of the cutting progress stage in the method for cutting concrete member of the present invention.

FIG. 4 is a schematic diagram showing a state of the self-burning stage in the method for cutting concrete member of the present invention.

FIG. 5 is a state of the arrangement of a laser head and a reinforced concrete block in the Examples.

FIG. 6 is a schematic diagram showing a cutting state in Example 1.

FIG. 7 is an appearance photograph of the reinforced concrete block immediately after stopping laser irradiation in Example 1.

FIG. 8 is an appearance photograph of the reinforced concrete block divided into two in Example 1.

FIG. 9 is an appearance photograph of the reinforced concrete block after stopping the irradiation of the laser to cool in air in Example 2.

FIG. 10 is an appearance photograph of the reinforced concrete block immediately after stopping laser irradiation in Example 3.

FIG. 11 is a schematic diagram showing a cutting state in Example 4.

FIG. 12 is an appearance photograph of the reinforced concrete block after stopping the irradiation of the laser to cool in air in Example 4.

FIG. 13 is an appearance photograph of the reinforced concrete block after stopping the irradiation of the laser to cool in air in Comparative Example 1.

FIG. 14 is an appearance photograph of the reinforced concrete block after stopping the irradiation of the laser to cool in air in Comparative Example 2.

FIG. 15 is a graph showing the relationship between the beam radius and the power density for obtaining a good cutting portion.

### MODE FOR CARRYING OUT THE INVENTION

In the following, by referring the drawings, the typical embodiments of the method for cutting concrete member of the present invention are explained, but the present invention is not limited thereto. In the following explanation, the same symbol is given to the same or corresponding parts, and there is a case where overlapping explanation is omitted. In addition, since these drawings are presented to explain the concept of the present invention, there are cases where size and ratio of the structural elements are different from the real case.

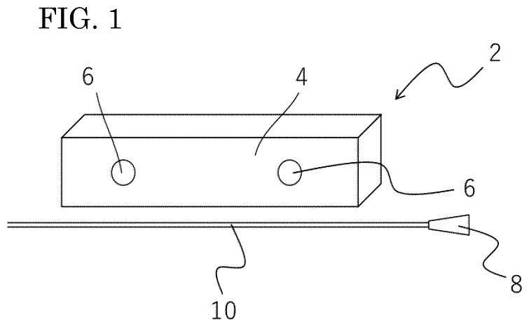

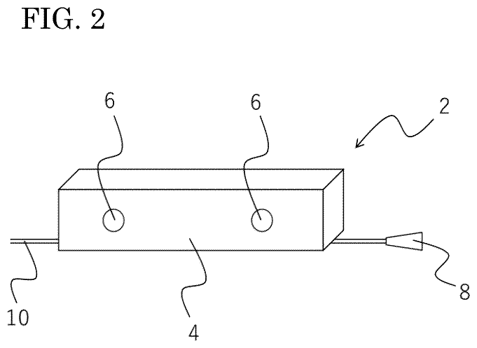

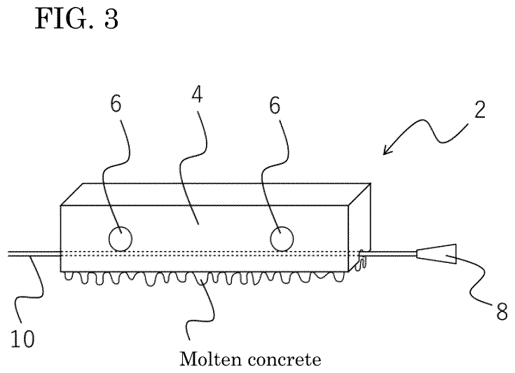

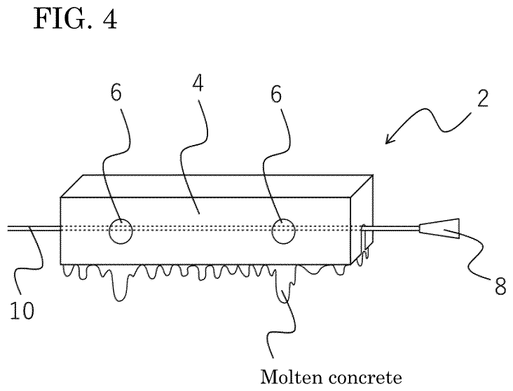

FIG. 1 to FIG. 4 schematically show one embodiment of the step of cutting concrete member by using the method for cutting concrete member of the present invention. FIG. 1 shows the pre-stage of the cutting, FIG. 2 shows the laser contact stage, FIG. 3 shows the cutting progress stage, and FIG. 4 shows the self-burning stage.

The material to be cut is a concrete member 2, and the concrete member 2 contains a concrete 4 and a steel material 6. The composition of the concrete 4 is not particularly limited as long as the effect of the present invention is not impaired, various conventionally known concrete can be used. Further, the kind and shape of the steel material 6 is not also particularly limited as long as the effect of the present invention is not impaired, and various conventionally known steel materials and their shapes can be used, and when the concrete member 2 is a usually used reinforced steel concrete or reinforced steel framed concrete, since the steel material 6 is present at an appropriate percentage in the concrete 4, it is possible to efficiently cut.

### 1. Pre-Stage of Cutting

As shown in FIG. 1, the antinode (side surface) of the laser 10 emitted from the laser head 8 is so provided as to be positioned in the vicinity of the surface to be cut of the concrete member 2. Here, in order that the molten concrete 4 is discharged from the cutting area by using gravity, it is preferable that the surface to be cut is the bottom surface (lower surface in the direction of gravity) of the concrete member.

The kind of the laser 10 is not particularly limited as long as the effect of the present invention is not impaired, and conventionally known various lasers can be used, and, for example, it is preferable to use a semiconductor laser, a fiber laser, or the like.

Further, the laser output and the power density of the laser 10 may be appropriately set according to the desired cutting speed and the size, shape, composition and the like of the concrete member 2, and it is preferable to set the power density to an appropriate value or more according to a beam diameter of the laser. More specifically, when the beam shape in the irradiation area is substantially circular, it is preferable that the power density is 3.5 kW/mm² or more when the beam radius is 1.2 mm, the power density is 1.0 kW/mm² when the beam radius is 2.2 mm, the power density is 0.5 kW/mm² or more when the beam radius is 3.2 mm, the power density is 0.3 kW/mm² or more when the beam radius is 4.2 mm, the power density is 0.2 kW/mm² or more when the beam radius is 5.2 mm. When setting the power density to these values, the concrete member can be efficiently melted.

Further, the scanning speed of the laser 10 may be also appropriately set according to the output and power density of the laser 10, the size, shape and composition, and the like of the concrete member 2, and the like, and it is preferable that the scanning speed of the laser is 5 to 50 mm/min. When setting the laser scanning speed to 5 mm/min or more, a practical cutting speed for cutting the concrete members can be secured, and when setting to 50 mm/min or less, it is possible to accelerate the progress of the self-burning and the discharge of the molten concrete.

### 2. Laser Contact Stage

As shown in FIG. 2, this stage is a stage where the side surface of the laser 10 is brought into contact with the surface of the concrete member 2. It is preferable that, at the start position of the cutting the concrete member 2, the side surface of the laser 10 is brought into contact with the outer peripheral surface of the concrete member 2, and the position of the laser 10 is fixed until the molten region of the concrete 4 is formed around the entire circumference of the laser 10. When forming the molten region of the concrete 4 around the entire circumference of the laser 10 while the side surface of the laser 10 is brought into contact with the outer peripheral surface of the concrete member 2, the energy of the laser 10 can be fully utilized.

The time for holding the laser 10 at the position in contact with the outer peripheral surface of the concrete member 2 may be appropriately adjusted, and it is possible to form the molten region of the concrete 4 around the entire circumference of the laser 10 for the holding time of several seconds to several tens of seconds.

### 3. Cutting Progress Stage

As shown in FIG. 3, this is a stage where the laser 10 is scanned in the cutting direction. The concrete member 2 can be cut by scanning the laser 10 in an arbitrary traveling direction from the outer peripheral surface of the concrete member 2. Here, from the viewpoint of discharging the molten concrete 4 from the cutting area by utilizing gravity, it is preferable to operate the laser 10 upward in the direction of gravity, but, for example, the laser may be scanned obliquely upward, or may be scanned obliquely upward and then in the horizontal direction or the like.

When providing the cutting area on at least a part of the bottom surface of the concrete member 2 at the start of the cutting, the molten concrete can be efficiently discharged by gravity.

When the laser 10 is in contact only with the concrete 4 of the concrete member 2, almost no positional dependence is observed in the discharge of molten concrete, and the same amount of the molten concrete is successively discharged from the entire cutting area.

### 4. Self-Burning Stage

As shown in FIG. 4, this is a stage where the heat input from the laser 10 promotes the self-burning of the steel material 6 and the melting of the concrete 4 is accelerated. When the influence of the laser 10 reaches the steel material 6 and the temperature of the steel material 6 rises due to the heat input from the laser 10 and the self-burning progresses, since the heat generation accelerates the melting of the concrete 4 in the vicinity of the steel material 6, the amount of melted concrete 4 flowing out from the vicinity of the steel material 6 increases, and thus the concrete member 2 can be cut efficiently.

The presence or absence of the self-burning of the steel material 6 can be easily confirmed from the discharge state of the molten concrete during cutting. Specifically, as shown in FIG. 4, the amount of the molten concrete discharged from the vicinity of the steel material 6 significantly increases.

Although representative embodiments of the present invention have been described above, the present invention is not limited to these, and various design changes are possible, and all such design changes are included in the technical scope of the present invention.

### EXAMPLE

### Example 1

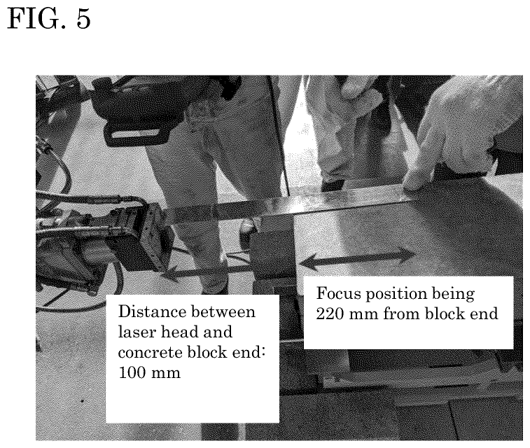

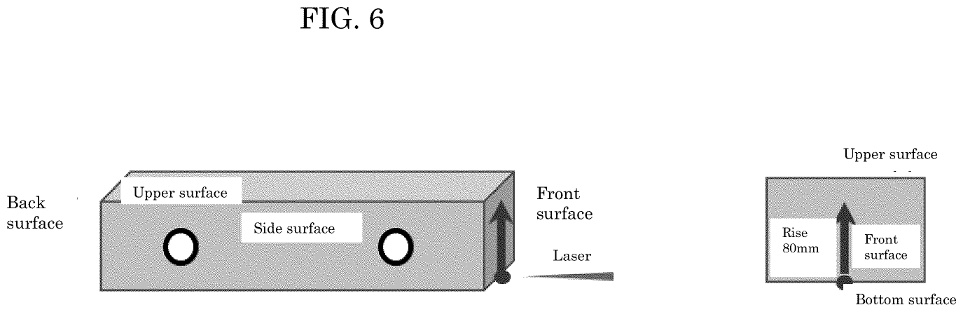

An attempt was made to cut a reinforced concrete block by using a semiconductor laser with a maximum output of 50 kW. FIG. 5 shows the state of the arrangement of a laser head and a reinforced concrete block. Further, FIG. 6 shows schematically the state of cutting. The reinforced concrete block is a rectangular body of 100 mm×150 mm×500 mm, and the laser head is arranged at a position facing the longitudinal side of the reinforced concrete block.

The distance between the end of the reinforced concrete block and the laser head was 100 mm, and the focal position of the laser was 220 mm in the depth direction from the end of the reinforced concrete block. Further, the laser beam was kept in contact with the surfaces to be joined for 30 seconds to form a molten area of the concrete around the entire circumference of the laser, and then scanned in the cutting direction. Table 1 shows the cutting conditions such as laser output and laser scanning speed.

TABLE 1

| | | Laser | | |
|---|---|---|---|---|
| | | output | Laser scanning | |
| | Member to be cut | (kW) | speed (mm/min) | Cutting direction |
| Ex. 1 | Reinforced concrete | 20 | 12 | Directly above bottom |
| | (Steel: φ38 mm, two) | | | surface |
| Ex. 2 | Reinforced concrete | 30 | 12 | Directly above bottom |
| | (Steel: φ38 mm, two) | | | surface |
| Ex. 3 | Reinforced concrete | 20 | 12 | Obliquely 60° above |
| | (Steel: φ25 mm, four) | | | the bottom surface |
| Ex. 4 | Reinforced concrete | 20 | 12 | Sideway from side |
| | (Steel: φ25 mm, four) | | | surface |
| Com. EX. 1 | Concrete | 20 | 6 | Directly above bottom |
| | | | | surface |
| Com. Ex. 2 | Concrete | 30 | 12 | Directly above bottom |
| | | | | surface |

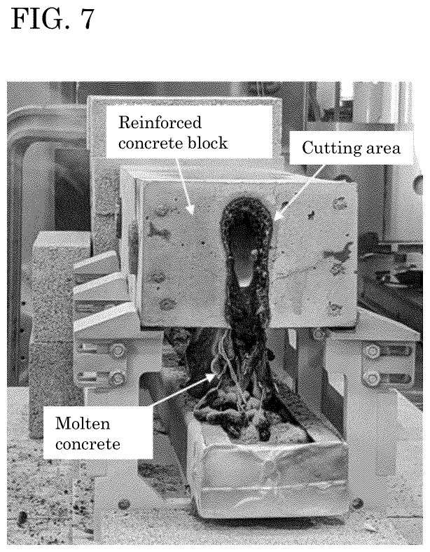

After the laser was scanned 80 mm directly above the bottom surface of the reinforced concrete block, the laser irradiation was stopped. FIG. 7 shows an appearance photograph of the reinforced concrete block immediately after stopping laser irradiation. It can be seen that the molten concrete is discharged downward in the direction of gravity, and that a good cut portion corresponding to the scanning of the laser is formed.

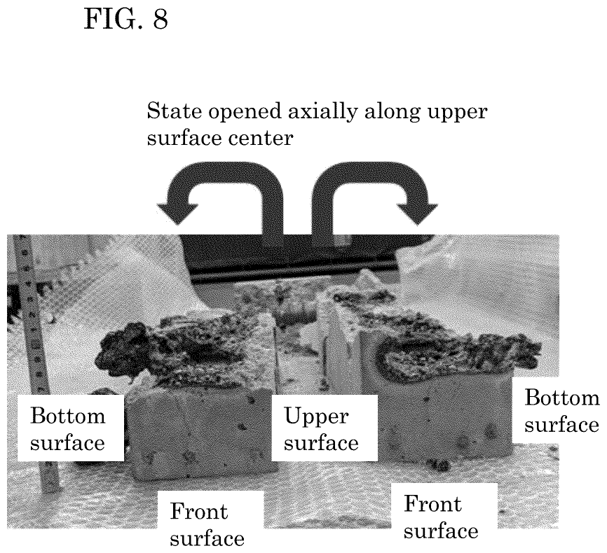

After the reinforced concrete block in the state shown in FIG. 7 was air-cooled, external stress was applied manually with a chisel and a hammer, and the reinforced concrete block was easily split into two. FIG. 8 shows an appearance photograph of the reinforced concrete block after division.

### Example 2

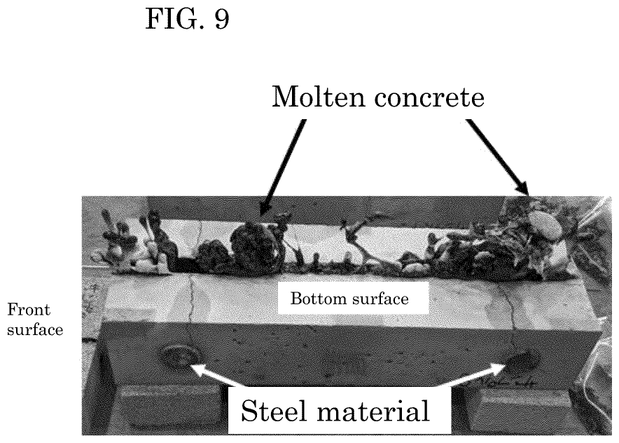

An attempt was made to cut a reinforced concrete block in the same manner as in Example 1, except that the laser output was 30 kW. FIG. 9 shows an appearance photograph of the reinforced concrete block obtained after scanning with a laser beam 80 mm directly above the bottom surface of the reinforced concrete block, and then stopping the laser irradiation and air-cooling the block. Although the top and bottom surfaces of the reinforced concrete block are reversed in the photograph of FIG. 9, it can be seen that the discharge of the molten concrete is accelerated from the vicinity of the area where the reinforcing steel material is present. The results imply that the self-burning of the reinforcing steel material accelerates the cutting.

### Example 3

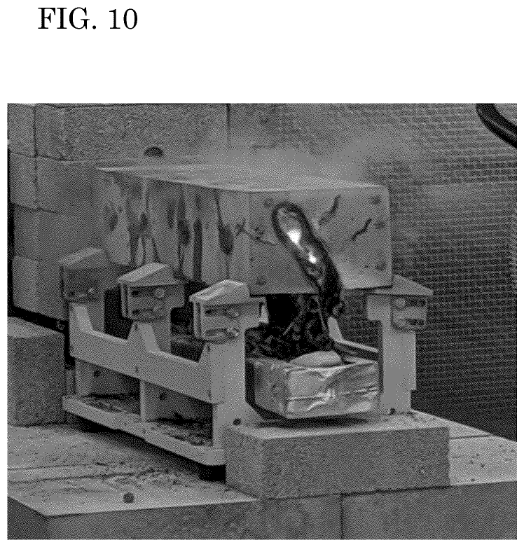

An attempt was made to cut a reinforced concrete member in the same manner as in Example 1 except that the conditions shown as Example 3 in Table 1 were employed. After scanning with a laser 80 mm obliquely 60° above the bottom surface of the reinforced concrete block, the laser irradiation was stopped. FIG. 10 shows an appearance photograph of the reinforced concrete block immediately after stopping laser irradiation. Even when the block is cut obliquely, a good cut is formed, and it can be confirmed that molten concrete is discharged from the opening at the bottom of the concrete block.

### Example 4

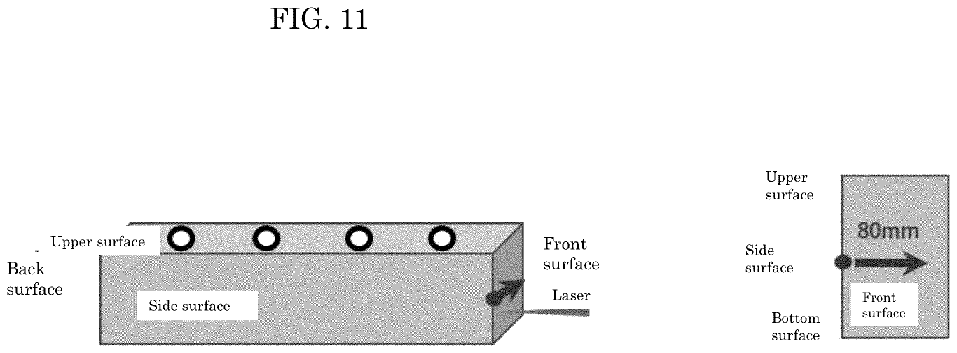

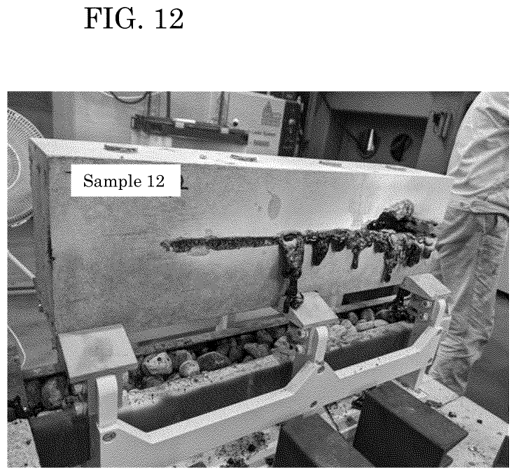

An attempt was made to cut a reinforced concrete member in the same manner as in Example 1 except that the conditions shown as Example 4 in Table 1 were employed. FIG. 11 shows schematically the state of cutting. After scanning with a laser sideway 80 mm from the side of the reinforced concrete block, the laser irradiation was stopped. FIG. 12 shows an appearance photograph of the reinforced concrete block air-cooled after stopping the laser irradiation. Although a cut portion can be formed even when the laser beam is scanned sideway from the side of the reinforced concrete block, discharge of the molten concrete and cutting do not progress smoothly in comparison with the case where the bottom has an opening.

### Comparative Example 1

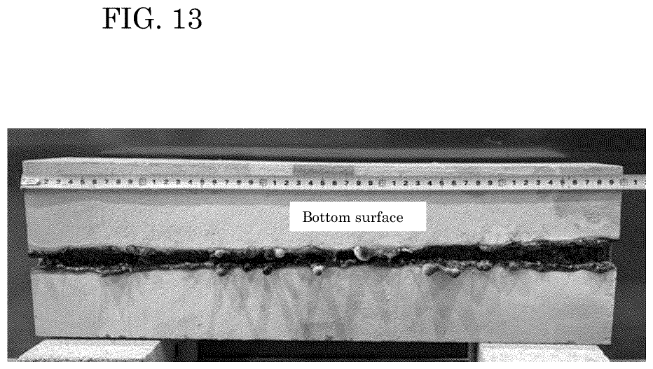

An attempt was made to cut a concrete block in the same manner as in Example 1 except that a solid concrete block was used as the material to be cut and the laser scanning speed was set to 6 mm/min. After scanning with a laser 15 mm directly upward from the bottom surface of the concrete block, the laser irradiation was stopped. FIG. 13 shows an appearance photograph of the reinforced concrete block after stopping the irradiation of the laser to cool in air. Although the cut area is formed, it can be seen that the amount of the molten concrete discharged is small in comparison with the Example even if the laser scanning speed is slowed down.

### Comparative Example 2

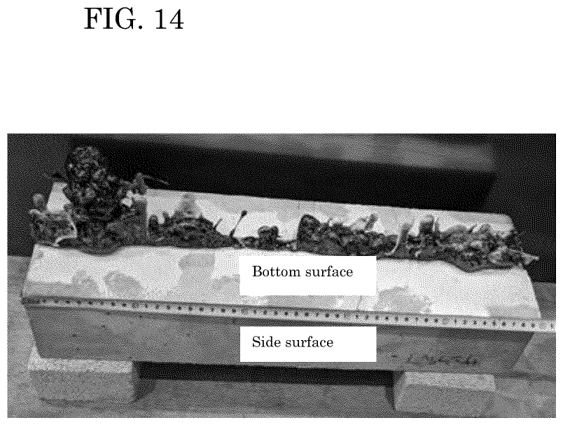

An attempt was made to cut a concrete block in the same manner as in Example 2 except that a solid concrete block was used as the material to be cut. FIG. 14 shows an appearance photograph of the concrete block obtained after scanning with a laser beam 80 mm directly above the bottom surface of the concrete block, and then stopping the laser irradiation and air-cooling the block. Although the top and bottom surfaces of the reinforced concrete block are reversed in the photograph of FIG. 14, it can be seen that, compared with the results of Example 2 (FIG. 9) under the same cutting conditions, it can be seen that the amount of the molten concrete discharged is small and the cutting efficiency is poor.

### [Influence of Laser Spot Diameter and Power Density on Cutting of Concrete Members]

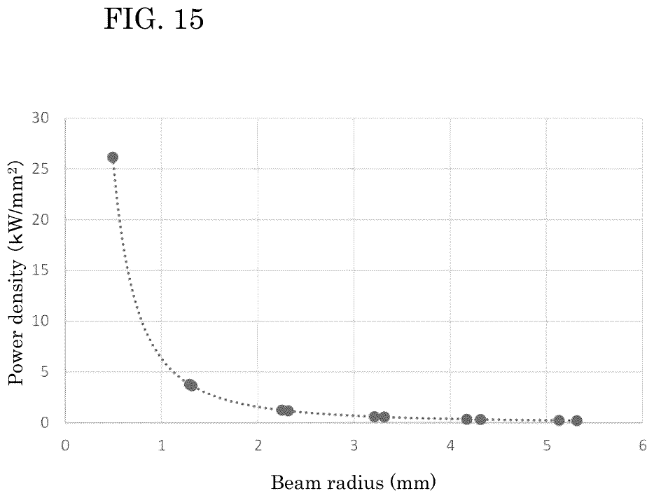

In the laser irradiation conditions described in Example 1 where a good cut portion corresponding to laser scanning was formed, the relationship between the beam radius and the power density was measured. Specifically, since the beam diameter increases as the distance from the focus position increases, the beam radius and power density were measured at each position of the distances from the focus position are −250 mm, −200 mm, −150 mm, −100 mm, −50 mm, 0 mm, 50 mm, 100 mm, and 150 mm, 200 mm and 250 mm. A beam profiler available from Primes was used for these measurements. The results are shown in Table 2. Further, FIG. 15 shows the relationship between the beam radius and the power density.

TABLE 2

| Distance from focus | Beam radius | Power density |
|---|---|---|
| (mm) | (mm) | (kW/mm²) |
| −250 | 5.128 | 0.240 |
| −200 | 4.168 | 0.363 |
| −150 | 3.208 | 0.612 |
| −100 | 2.248 | 1.247 |
| −50 | 1.288 | 3.797 |
| 0 | 0.491 | 26.144 |
| 50 | 1.313 | 3.658 |
| 100 | 2.313 | 1.179 |
| 150 | 3.313 | 0.574 |
| 200 | 4.313 | 0.339 |
| 250 | 5.313 | 0.223 |

The graph in FIG. 15 shows the boundary conditions of the laser for obtaining good cutting portion, and when setting the beam radius and the power density to the area of the top right side of the curve that linked the plots, the concrete can be melted efficiently.

### EXPLANATION OF SYMBOLS

2 . . . Concrete member,
4 . . . Concrete,
6 . . . Steel material,
8 . . . Laser head,
10 . . . Laser,
20 . . . Cutting area.

1. A method for cutting concrete member through irradiation of the concrete member with a laser, the method being characterized in that:
the concrete member includes a steel material;
the concrete is melted by scanning the laser thereon to form a cutting region;
the steel material is heated by means of the laser to a temperature that causes progression of self-burning of the steel material; and
the melting of the concrete is accelerated by heat generation from the self-burning.

2. The method for cutting concrete member according to claim 1, wherein the cutting region is formed by using the side surface of the laser.

3. The method for cutting concrete member according to claim 1, wherein the cutting is started from the outer peripheral surface of the concrete member.

4. The method for cutting concrete member according to claim 2, wherein the side surface of the laser is brought into contact with the outer peripheral surface of the concrete member at the start position of the cutting, and the position of the laser is fixed until the molten region of the concrete is formed around the entire circumference of the laser.

5. The method for cutting concrete member according to claim 4, wherein at least part of the bottom surface of the concrete member is included in the start position of the cutting.

6. The method for cutting concrete material according to claim 1, wherein
the laser is scanned from the lower side of the concrete member in the direction of gravity toward the upper side in the direction of gravity to form the cutting area, and
the molten concrete is discharged from the cutting area by gravity.

7. The method for cutting concrete member according to claim 1, wherein the scanning direction of the laser is substantially vertical.
